(19) United States
(12) Patent Application Publication
(10) Pub. No.: US 2007/0222773 A1
(43) Pub. Date: Sep. 27, 2007

(54) DISPLAY APPARATUS AND DISPLAY METHOD

(75) Inventors: Shunsuke Konno, Kanagawa (JP); Toshitomo Umei, Kanagawa (JP); Takashi Kuwabara, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/689,020

(22) Filed: Mar. 21, 2007

Related U.S. Application Data
(60) Provisional application No. 60/877,006, filed on Dec. 26, 2006.

(30) Foreign Application Priority Data
Mar. 22, 2006 (JP) 2006-079682

(51) Int. Cl. G09G 5/00

(52) U.S. Cl. 345/204

(57) ABSTRACT

Problem: To expand an image or video at predetermined expansion rates, thereby enabling a viewer to view the image or video at the original aspect ratio when viewing the image or video from an oblique direction, making the image or video easy to see.

Solving means: View direction detection section 101 detects the direction from which a viewer, who is a fellow passenger of a vehicle, views the display surface of display section 105. Expansion rate control section 103 controls expansion rates so as to select the expansion rates that correspond to the detected direction from which the viewer views the display surface and expand the image or video using the selected expansion rates. Signal processing section 104, in accordance with the control performed by expansion rate control section 103, expands the image or video at the expansion rates selected by expansion rate control section 103. Display section 105 displays the expanded image or video.

### CROSS REFERENCE TO RELATED APPLICATIONS

The disclosure of Japanese Patent Application No. 2006-079682, filed on Mar. 22, 2006, and U.S. Provisional Patent Application 60/877,006 filed on Dec. 26, 2006, including the specification, drawings and abstract, is incorporated herein by reference in its entirety.

### BACKGROUND OF THE INVENTION

1. Field of the Invention

The present invention relates to a display apparatus and display method, and, more particularly, to a display apparatus and display method for fellow passengers in a vehicle to view video inside the vehicle.

2. Description of the Related Art

Conventionally, for the fellow passengers in a vehicle, a display apparatus is installed on the back of the front seat and video is displayed on the installed display apparatus. This allows the fellow passenger or the plurality of fellow passengers seated in the backseat to enjoy the video displayed on the display apparatus while the vehicle is moving.

However, a fellow passenger seated in the backseat may view the video displayed on the display apparatus from an oblique direction. That is, when video is displayed on a display apparatus positioned higher than a fellow passenger seated in a seat, such as when video is displayed on a display apparatus installed on the ceiling inside a vehicle, viewer 1, as shown in FIG. 12, views the video displayed on display surface 2 at view angle θv (See Japanese Patent Application Laid-Open No. 2004-82835, for example). Further, when viewer 1 is a child at a low seated height, the child who is the viewer views the video at view angle θv. Further, when a display apparatus is installed in an intermediate position between the driver's seat and front passenger's seat, as shown in FIG. 13, viewers 10 and 11 end up viewing display surface 12 at view angle θh (See Japanese Patent Application Laid-Open No. 2004-293195, for example).

Nevertheless, with the conventional apparatus, when a viewer views video displayed on a display surface at view angle θv, as shown in FIG. 12, the compression ratio in the vertical direction of the video that is displayed decreases as view angle θv increases, causing the video to appear further compressed in the vertical direction, as shown in FIG. 14. Further, when a viewer views video displayed on a display surface at view angle θv as shown in FIG. 13, the compression ratio in the horizontal direction of the video that is displayed decreases as view angle θh increases, causing the video to appear further compressed in the horizontal direction, as shown in FIG. 15.

In the vehicle, the fellow passengers in the backseat are in close proximity with the screen, and the size of the screen is limited so as not to affect driving performance. Consequently, the view angle at which the fellow passengers view the screen is greater than that when viewing a television at home, even when the fellow passengers in the backseat move slightly to the side from the location directly in front of the screen. Thus, when a fellow passenger views video from an oblique direction, the displayed video appears compressed in the horizontal direction and vertical direction to the fellow passenger in the backseat, making it impossible to view the video at the aspect ratio viewed from a location directly in front of the display apparatus, thereby making the displayed video difficult to see. The difficulty in seeing the video is particularly severe when the screen is a wide screen that is wide in the horizontal direction.

### SUMMARY OF THE INVENTION

It is therefore an object of the present invention to provide a display apparatus and display method that enable a viewer to view image or video at the original aspect ratio when viewing the image or video from an oblique direction and make the image or video easier to see.

The display apparatus of the present invention employs a configuration having: a display section that displays an image or video on a display surface; an expansion rate control section that expands the image or video in a horizontal direction or a vertical direction at predetermined expansion rates and displays the image or video on the display surface; and an expansion rate setting section that sets or selects the expansion rates used in the expansion rate control section.

The display method of the present invention has an expansion rate control step of expanding image or video in a horizontal direction or a vertical direction at predetermined expansion rates; an expansion rate setting step of setting or selecting the expansion rates used in the expansion rate control step; and a display step of displaying the image or video expanded in the horizontal direction or the vertical direction at the expansion rates set or selected.

The present invention expands image or video at predetermined expansion rates, thereby enabling a viewer to view the image or video at the original aspect ratio when viewing the image or video from an oblique direction, making the image or video easy to see.

### BRIEF DESCRIPTION OF THE DRAWINGS

FIG. 1 is a block diagram showing the configuration of a vehicle-mounted display apparatus according to Embodiment 1 of the present invention;

FIG. 2 is a flowchart showing an image display method according to Embodiment 1 of the present invention;

FIG. 3 is a diagram showing a view angle of a viewer according to Embodiment 1 of the present invention;

FIG. 4 is a diagram showing a view angle of a viewer according to Embodiment 1 of the present invention;

FIG. 5 is a diagram showing the relationship between a display surface and view angle according to Embodiment 1 of the present invention;

FIG. 6 is a flowchart showing an image display method according to Embodiment 2 of the present invention;

FIG. 7 is a diagram showing maximum expansion rate selection information according to Embodiment 2 of the present invention;

FIG. 8 is a diagram showing a state of image expansion and compression according to Embodiment 2 of the present invention;

FIG. 9 is a block diagram showing the configuration of a vehicle-mounted display apparatus according to Embodiment 3 of the present invention;

FIG. 10 is a diagram showing a view angle of a viewer according to Embodiment 3 of the present invention;

FIG. 11 is a block diagram showing a configuration of a vehicle-mounted display apparatus according to Embodiment 4 of the present invention;

FIG. 12 is a diagram showing a view angle of a viewer;

FIG. 13 is a diagram showing a view angle of a viewer;

FIG. 14 is a diagram showing the relationship between the compression rate in the vertical direction and view angle in the vertical direction; and

FIG. 15 is a diagram showing the relationship between the compression rate in the horizontal direction and view angle in the horizontal direction.

### DETAILED DESCRIPTION OF THE PREFERRED EMBODIMENT

Now embodiments of the present invention will be described in detail with reference to the accompanying drawings.

### Embodiment 1

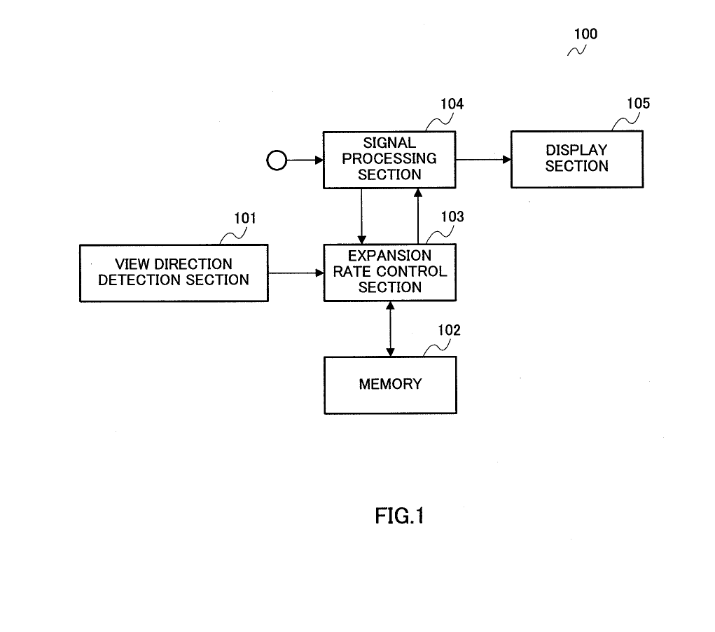

FIG. 1 is a block diagram showing the configuration of vehicle-mounted display apparatus 100 according to Embodiment 1 of the present invention.

View direction detection section 101 is provided with, for example, a switch for reporting the view direction of a viewer, who is a fellow passenger of the vehicle, and detects the direction from which the viewer views the display surface of display section 105 when the viewer presses the switch. For example, view direction detection section 101 detects the angle in the vertical direction (hereinafter “vertical view angle”) and the angle in the horizontal direction (hereinafter “horizontal view angle”) formed by the line connecting the center of the display surface and viewer and the line perpendicular to the display surface and passing through the center of the display surface as the direction from which the viewer views the display surface of display section 105. Then, view direction detection section 101 outputs information about the detected horizontal view angle and vertical view angle to expansion rate control section 103.

Memory 102 stores expansion rate selection information for selecting expansion rates.

Expansion rate control section 103, using the horizontal view angle and vertical view angle information input, from view direction detection section 101, refers to the expansion rate selection information stored in memory 102 and selects the respective expansion rates for the horizontal direction and the vertical direction. Then, expansion rate control section 103 outputs to signal processing section 104 expansion rate information that includes information about the expansion rate selected for the horizontal direction and expansion rate selected in the vertical direction. The details of the method for selecting expansion rates will be described later.

When image data or video data is inputted by the playback of image or video recorded on a recording medium, for example, signal processing section 104 expands and outputs to display section 105 the image of the input image data or the video of the input video data at the expansion rate of the horizontal direction and the expansion rate of the vertical direction in the expansion rate information inputted from expansion rate control section 103.

Display section 105 comprises a display surface of a liquid crystal display screen, for example, and displays on the display surface the image or video inputted from signal processing section 104.

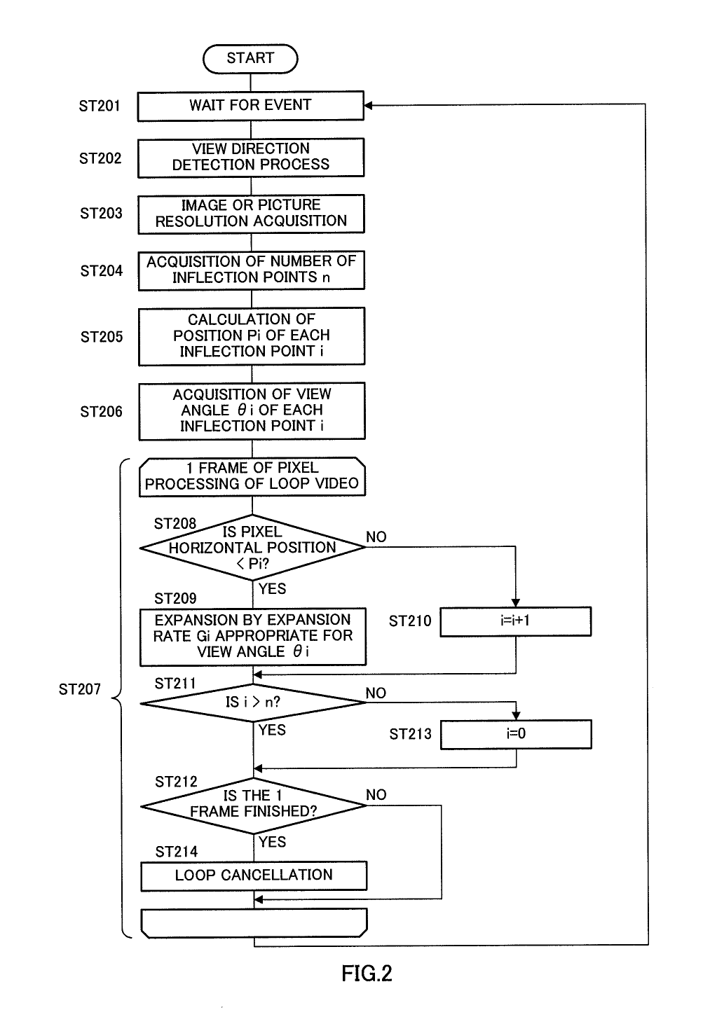

Next, the display method for displaying image or video using vehicle-mounted display apparatus 100 will be described with reference to FIG. 2. FIG. 2 is a flowchart showing a display method of displaying image or video.

Initially, vehicle-mounted display apparatus 100 is in an event wait state (step ST201).

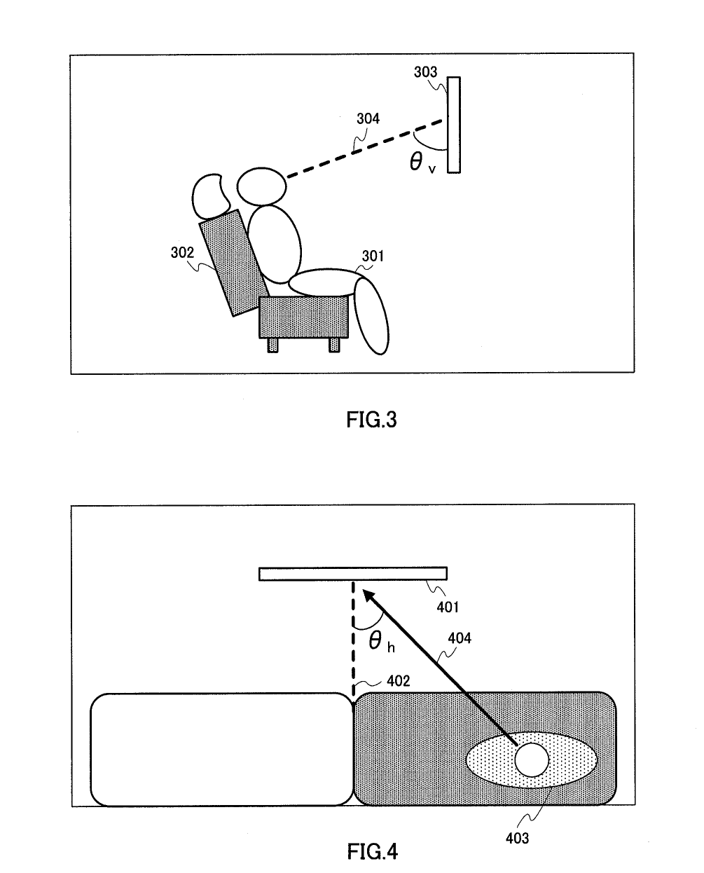

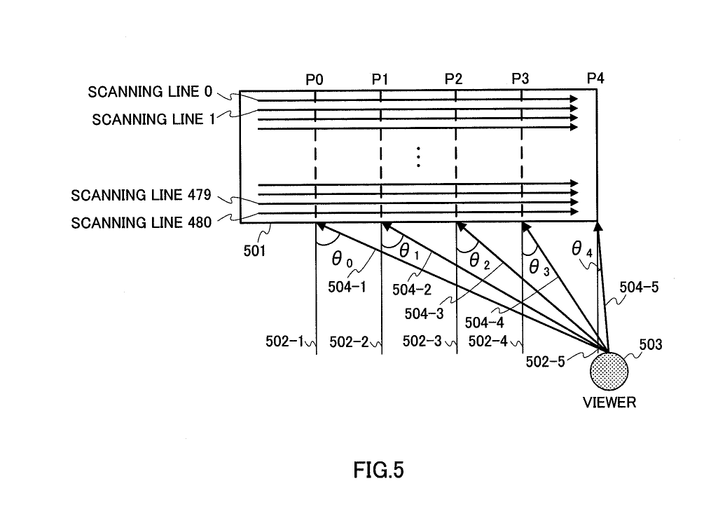

Next, view direction detection section 101 detects the direction from which a viewer views display section 105 when the view direction of the viewer is inputted from a switch (view direction detection process: step ST202). To be more specific, view direction detection section 101 detects vertical view angle θv and horizontal view angle θh. Here, vertical view angle θv, as shown in FIG. 3, is the angle formed by line 304 connecting viewer 301 and the center of display surface 303, and display surface 303, when display surface 303 is level with viewer 301 and perpendicular to the ground. Here, horizontal view angle θh, as shown in FIG. 4, is the angle formed by line 404 connecting viewer 403 and the center of display surface 401 and line 402 perpendicular to display surface 401 and passing through the center of display surface 401, when display surface 401 is level with viewer 403 and perpendicular to the ground. For example, view direction detection section 101 is provided with a switch that allows a viewer to manually input the view angle of the viewer, that is, the angle at which the viewer views the display surface. Then, when the viewer operates the switch and selects the angles in the horizontal direction and vertical direction from which the viewer views the display surface, view direction detection section 101 detects vertical view angle θv and horizontal view angle θh.

Next, signal processing section 104 acquires the resolution of the image of the input image data or the video of the input video data (step ST203), and outputs resolution information, which is information about the acquired resolution, to expansion rate control section 103.

Next, expansion rate control section 103 acquires the number n of inflection points on the display surface, based on the resolution of the resolution information inputted from signal processing section 104 (step ST204).

Next, expansion rate control section 103 calculates horizontal position Pi on the display surface of each inflection point i, based on the resolution of the display surface of display section 105 stored in advance and the acquired number n of inflection points. To be more specific, expansion rate control section 103 finds horizontal position Pi using equation 1:
Pi=i×(L/N) (Equation 1)
Where, i is the inflection point, Pi is the horizontal position on the display surface of each inflection point i, L is the horizontal length of the display surface, and N is the number of divisions of the display surface.

Next, expansion rate control section 103 acquires view angle θi of the viewer per inflection point, based on horizontal position Pi on the display surface of each inflection point and horizontal view angle θh (step ST206). Specifically, memory 102 stores the inflection point and view angle selection information that associates the horizontal view angle θh with the view angle per horizontal position Pi, and expansion rate control section 103, using the calculated horizontal position Pi and the horizontal view angle θh detected by view direction detection section 101, refers to the inflection point and view angle selection information and selects view angle θi per horizontal position Pi.

FIG. 5 is a diagram showing an example of the view angle θi per inflection point (i=0 to 4). Here, each view angle θi, as shown in FIG. 5, is the angle formed by lines 504-1 to 504-5 connecting viewer 503 and horizontal position Pi and lines 502-1 to 502-5 perpendicular to display surface 501 at each of the horizontal positions Pi in the horizontal direction (left/right direction in FIG. 5) of display surface 501 of each inflection point i. In the case of FIG. 5, the number of inflection points n is 5, and the horizontal position Pi of each inflection point i is the respective position of P0 to P4 shown in FIG. 5. As shown is FIG. 5 view angle θi is θ0 for position P0, θ1 for position P1, θ2 for position P2, θ3 for position P3, and θ4 for position P4, and shows the relationship θ1>θ2>θ3>θ4. Furthermore, display surface 501 has 481 scanning lines, of horizontal scanning lines 0 to 480.

Next, vehicle-mounted display apparatus 100 processes the pixels of one frame of video (step ST207). Expansion rate control section 103 then judges whether or not the pixel horizontal position on the display surface of one horizontal scanning line from step ST207 is less than horizontal position Pi (step ST208).

When the pixel horizontal position is less than the horizontal position Pi, expansion rate control section 103 acquires expansion rate Gi suitable for view angle θi, and signal processing section 104 expands the image or video based on expansion rate Gi.

On the other hand, when the pixel horizontal position is not less than horizontal position Pi in step ST208, expansion rate control section 103 adds 1 to the value of i (step ST210).

Next, expansion rate control section 103 judges whether or not the value of i is greater than the number n of inflection points (step ST211). When the value of i is greater than the number n of inflection points, expansion rate control section 103 judges whether or not the pixel processing of one frame of video is finished (step ST212).

On the other hand, when the value of i is not greater than the n number of inflection points in step ST211, expansion rate control section 103 sets the value of i to 0 (step ST213). Then, expansion rate control section 103 judges whether or not the pixel processing of one frame of video is finished (step ST212).

Next, when the pixel processing of one frame of video is judged to be finished in step ST212, expansion rate control section 103 cancels the loop of step ST207 (step ST214) and enters the event wait state of step ST201. On the other hand, when the pixel processing of one frame of video is judged not to be finished in step ST212, expansion rate control section 103 continues the loop of step ST207. In this manner, view angle θi increases in proportion to the distance from viewer 503 in the horizontal direction of display surface 501, so that expanded image or video is displayed in an expanded state, at expansion rates gradually increasing in proportion to distance from viewer 503 in the horizontal direction of display surface 501.

In other words, expansion rate control section 103 expands the image or video on one display surface in a width direction (horizontal direction) or in a height direction (vertical direction) of the display surface at a plurality of different expansion rates corresponding to display positions and displays the image or video. The image or video may also be expanded in both directions. The expansion rates can be set appropriately according to relative position between the viewer and the display surface or the angle at which the viewer views the display surface. In the above description, the expansion rates are selected based on the angle information, but it is also possible to select one of sets (combinations) of fixed expansion rates set and stored in the memory in advance based on a operation of the viewer.

Thus, according to embodiment 1, when image or video is viewed from an oblique direction, the image or video is expanded at expansion rates that ensure that the image or video will not be viewed in a compressed state, thereby enabling a viewer to view the image or video at the original aspect ratio and making the image or video easier to see.

Furthermore, although embodiment 1 is described with reference to a case where image or video is viewed by one viewer, the present invention is not limited thereto and can also be applied to cases where the image or video is viewed by a plurality of viewers. In this case, the expansion rates may be selected by finding an expansion rate on a per viewer basis and then calculating the average.

### Embodiment 2

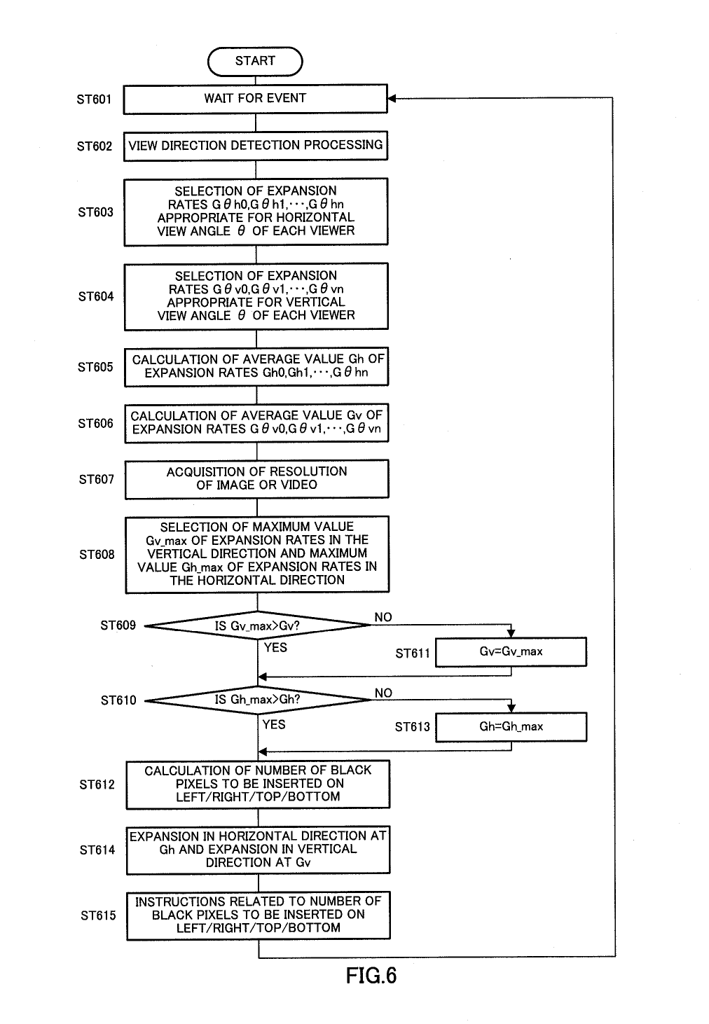

FIG. 6 is a flowchart showing the display method of displaying an image or video using a vehicle-mounted display apparatus. With FIG. 6, a case will be described where there are a plurality of viewers. Furthermore, the vehicle-mounted display apparatus of embodiment 2 has the same configuration as that of FIG. 1 and a description thereof is omitted.

Initially, the vehicle-mounted display apparatus is in an event wait state (step ST601).

Next, view direction detection section 101, provided with a number of switches equivalent to the number of people presumed to view image or video, detects the number of viewers n (where n is an arbitrary natural number) and the direction from which each viewer views the display surface of display section 105 by the input of the view direction of each viewer from the switches (step ST602). Specifically, view direction detection section 101 detects the number of viewers n seated in seats as well as vertical view angles θv0 to θvn and horizontal view angles θh0 to θhn per viewer. For example, view direction detection section 101 is provided with switches that allow each viewer to manually input the view angle of the viewer, that is, the angle at which the viewer views the display surface. Then, when each viewer operates the switch and selects the angles of the vertical direction and the horizontal direction from which he or she views the display surface, view direction detection section 101 detects vertical view angle θv0 to θvn and horizontal view angle θh0 to θhn.

Next, expansion rate control section 103 selects the expansion rates Gθh0 to Gθhn, based on the horizontal view angles θh0 to θhn detected by view direction detection section 101 (step ST603) To be more specific, memory 102 stores the expansion rate selection information that associates horizontal view angles θh0 to θhn with expansion rates, and expansion rate control section 103, using the horizontal view angles θh0 to θhn detected by view direction detection section 101, refers to the expansion rate selection information and selects expansion rates Gθh0 to Gθhn.

Next, expansion rate control section 103 selects the expansion rates Gθv0 to Gθvn, based on the vertical view angles θv0 to θvn detected by view direction detection section 101 (step ST604). To be more specific, memory 102 stores expansion rate selection information that associates vertical view angles θv0 to θvn with expansion rates, and, expansion rate control section 103, using the vertical view angles θv0 to θvn detected by view direction detection section 101, refers to the expansion rate selection information and selects expansion rates Gθv0 to Gθvn.

Next, expansion rate control section 103 calculates the average value Gh of expansion rates Gh0 to Ghn (step ST605).

Next, expansion rate control section 103 calculates the average value Gv of expansion rates Gθv0 to Gθvn (step ST606).

Next, expansion rate control section 103 acquires the resolution of the image of image data or the video of video data (step ST607).

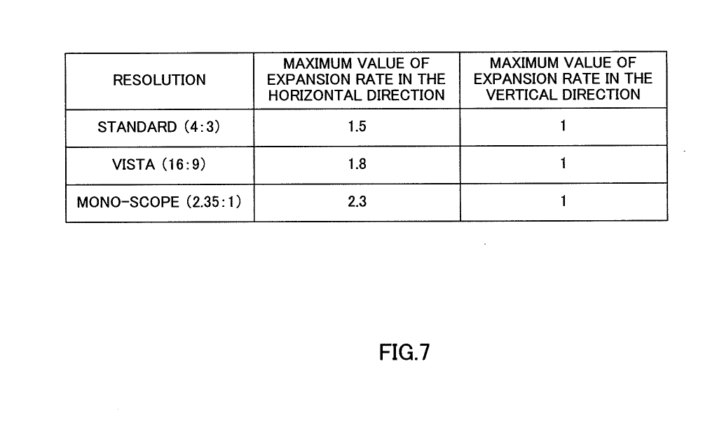

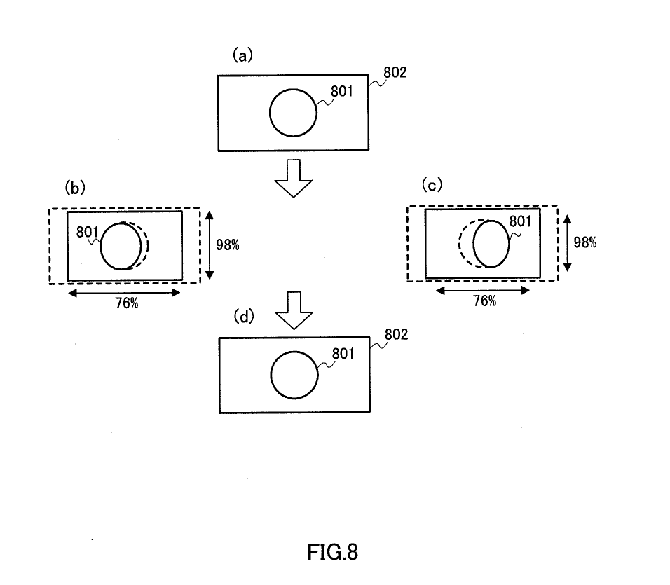

Next, expansion rate control section 103 acquires the maximum value Gv_max of the expansion rates in the vertical direction and selects the maximum value Gh_max of the expansion rates in the horizontal direction, based on the acquired resolution (step ST608) Specifically, as shown in FIG. 7, memory 102 stores the maximum expansion rate selection information that associates resolution with maximum expansion rate, and, using the acquired resolution, refers to the maximum value of the expansion rate for the horizontal direction and the maximum value of the expansion rate for the vertical direction while referring to the maximum expansion rate selection information.

Next, expansion rate control section 103 judges whether or not average value Gv is less than maximum value Gv_max of the expansion rate of the vertical direction (step ST609).

When average value Gv is less than maximum value Gv_max of the expansion rate of the vertical direction, expansion rate control section 103 selects average value Gv as the expansion rate of the vertical direction, and judges whether or not average value Gh is less than maximum value Gh_max of the expansion rate of the horizontal direction (step ST610).

On the other hand, when average value Gv is not less than maximum value Gv_max of the expansion rate of the vertical direction in step ST609, expansion rate control section 103 selects maximum value Gv_max of the expansion rate of the vertical direction as the expansion rate of the vertical direction (Gv=Gv_max; step ST611).

Next, when average value Gh is less than maximum value Gh_max of the expansion rate of the horizontal direction in step ST610, expansion rate control section 103 selects average value Gh as the expansion rate of the horizontal direction, and, based on the resolution, expansion rate of the horizontal direction, expansion rate in the vertical direction, and resolution of the display surface of display section 105, calculates the number of black pixels to be inserted in the top, bottom, left, and right of the display surface (step ST612).

On the other hand, when average value Gh is not less than maximum value Gh_max of the expansion rate of the horizontal direction in step ST610, expansion rate control section 103 selects maximum value Gh_max of the expansion rate of the horizontal direction as the expansion rate of the horizontal direction (Gh=Gh_max; step ST613).

Next, signal processing section 104 evenly expands the image of image data or the video of video data in the horizontal direction at expansion rate Gh and in the vertical direction at expansion rate Gv (step ST614).

Next, signal processing section 104 inserts black pixels in an amount equivalent to the number of black pixels to be inserted that was calculated by expansion rate control section 103 (step ST615). Then, the vehicle-mounted display apparatus enters the event wait state of step ST601.

FIG. 8 is a diagram comparing a conventional case where image is not expanded to the case according to embodiment 2 where image is expanded. When a viewer views display surface 802 straight on, as shown in FIG. 8 (a), image 801 is not viewed in a compressed state. On the other hand, when a viewer is seated in a position 10 degrees to the left from the straight-on position with respect to display surface 802, as shown in FIG. 8 (b), image 801 appears compressed at 76% leftward in the horizontal direction to the viewer. Further, when a viewer is seated in a position 10 degrees to the right from the straight-on position with respect to display surface 802, as shown in FIG. 8 (c), image 801 appears compressed at 76% rightward in the horizontal direction to the viewer. Further, when a viewer is seated in a position 40 degrees downward from the straight-on position with respect to display surface 802, as shown in FIG. 8 (b) (c), image 801 appears compressed at 98% upward in the vertical direction to the viewer.

In this case, expansion rate control section 103 expands image 801 at the expansion rates found by expansion rate=1/(100×cos θ). That is, expansion rate control section 103 controls the expansion rates so that the image is expanded at 131% in the horizontal direction and 102% in the vertical direction, based on the expansion rates found by the above-mentioned equation. Thus, the viewer, as shown in FIG. 8 (d), can view the image in the same state as image 801 of FIG. 8 (a) where the viewer views the image straight-on with respect to the display surface.

In this manner, according to embodiment 2, in addition to the effect of the above-described embodiment 1, when image or video is viewed by a plurality of viewers, the expansion rates in the vertical and horizontal directions selected by the viewers are averaged and the image or video expanded at the average expansion rate is displayed, thereby preventing the image or video from being easy to see for some viewers yet difficult to see for other viewers.

Furthermore, although embodiment 2 is described with reference to a case where image or video is viewed by a plurality of viewers, the present invention is not limited thereto and can also be applied to cases where image or video is viewed by one viewer.

In this case, the average value of expansion rates does not need to be found when selecting the expansion rates.

### Embodiment 3

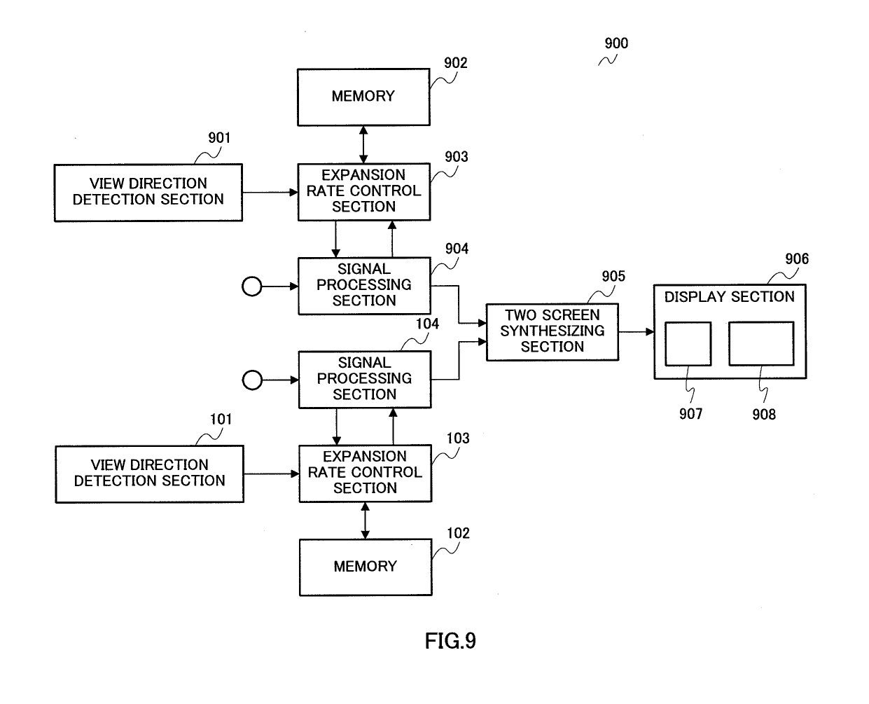

FIG. 9 is a block diagram showing the configuration of vehicle-mounted display apparatus 900 according to Embodiment 3 of the present invention.

Vehicle-mounted display apparatus 900 according to embodiment 3 has the same configuration as that of vehicle-mounted display apparatus 100 according to embodiment 1 shown in FIG. 1 only with view direction detection section 901, memory 902, expansion rate control section 903, signal processing section 904, and two screen combining section 905 added and display section 906 in place of display section 105, as shown in FIG. 11. Furthermore, the sections of FIG. 9 that have the same configurations as those of FIG. 1 are given the same reference numerals, and descriptions thereof are omitted.

View direction detection section 101 is provided with, for example, a switch for reporting the view direction of a viewer, who is a fellow passenger of the vehicle, and detects the direction from which the viewer views display surface 907 of display section 906 when the viewer presses the switch. For example, view direction detection section 101 detects the horizontal view angle and vertical view angle as the direction from which the viewer views display surface 907 of display section 906. Then, view direction detection section 101 outputs information about the detected horizontal view angle and vertical view angle to expansion rate control section 103.

When image data or video data are inputted by the playback of image or video recorded on a recording medium, for example, signal processing section 104 expands and outputs to two screen combining section 905 the image of the input image data or the video of the input video data at the expansion rate in the horizontal direction and expansion rate in the vertical direction of the expansion rate information inputted from expansion rate control section 103.

View direction detection section 901 is provided with, for example, a switch for reporting the view direction of a viewer, who is a fellow passenger of the vehicle, and detects the direction from which the viewer views display surface 907 of display section 908 when the viewer presses the switch. For example, view direction detection section 901 detects the horizontal view angle and vertical view angle as the direction from which the viewer views display surface 908 of display section 906. Then, view direction detection section 901 outputs information about the detected horizontal view angle and vertical view angle to expansion rate control section 903.

Memory 902 stores expansion rate selection information for selecting expansion rates.

Expansion rate control section 903, using the information about the horizontal view angle and vertical view angle inputted from view direction detection section 901, refers to the expansion rate selection information stored in memory 902 and selects the respective expansion rates for the horizontal direction and the vertical direction. Then, expansion rate control section 903 outputs to signal processing section 904 expansion rate information which includes information about the selected expansion rate of the horizontal direction and expansion rate of the vertical direction.

When image data or video data is inputted by the playback of image or video recorded on a recording medium, for example, signal processing section 904 expands and outputs to two screen combining section 905 the image of the input image data or the video of the input video data at the expansion rate of the horizontal direction and expansion rate of the vertical direction of the expansion rate information inputted from expansion rate control section 903.

Two screen combining section 905 combines and outputs to display section 906 the image data or video data inputted from signal processing section 104 and the image data or video data inputted from signal processing section 904 to separately display the image or video on two screens on a single display surface. Further, when image data or video data is inputted from only one of signal processing section 104 and signal processing section 904, two screen combining section 905 outputs the input image data or video data to display section 906 without performing the combining process for display on two screens. Display section 906 is capable of separately displaying image or video on the two display surfaces 907 and 908, displaying the image of image data or the video of video data inputted from two screen combining section 905 and processed by signal processing section 104 as well as the image of image data or the video of video data inputted from two screen combining section 905 and processed by signal processing section 904. Further, when only one of the image data or video data processed by signal processing section 104 and the image data or video data processed by signal processing section 904 is inputted from two screen combining section 905, display section 906 displays the image of the input image data or the video of the input video data either on the applicable display surface 907 or 908 or on a single display surface. Furthermore, the display method for displaying image or video using vehicle-mounted display apparatus 900 is the same as that of FIG. 2 or FIG. 6, and a description thereof is omitted.

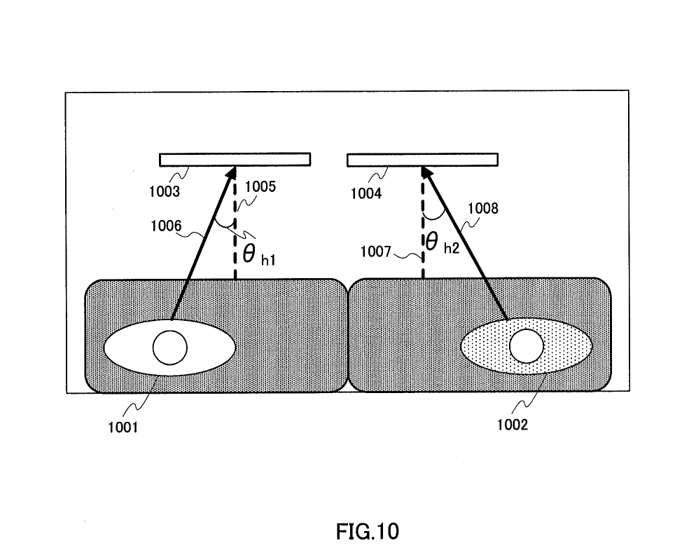

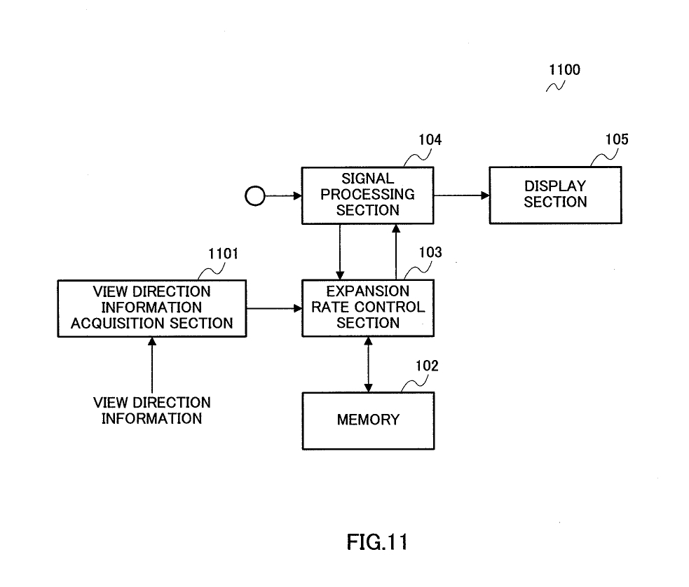

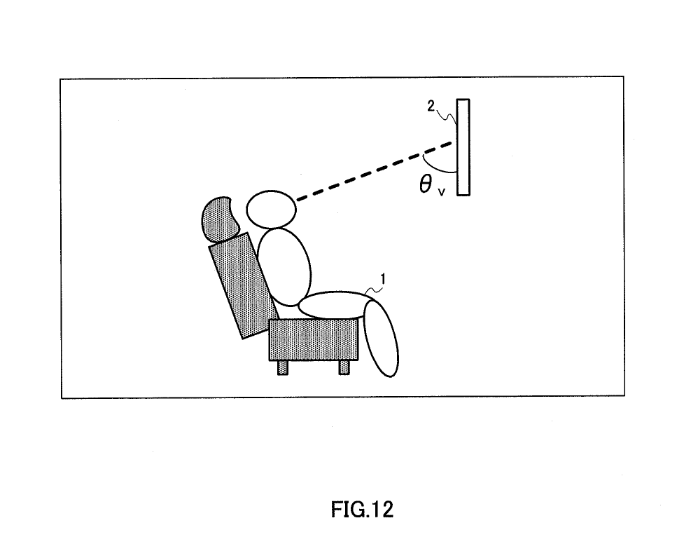

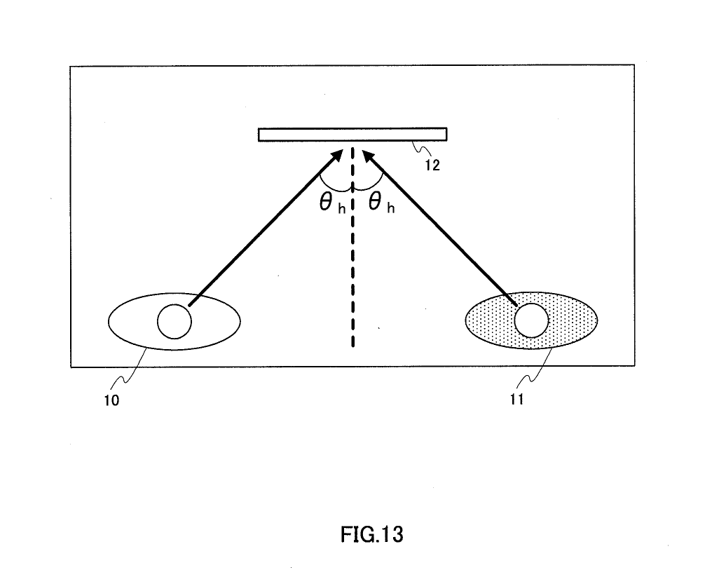

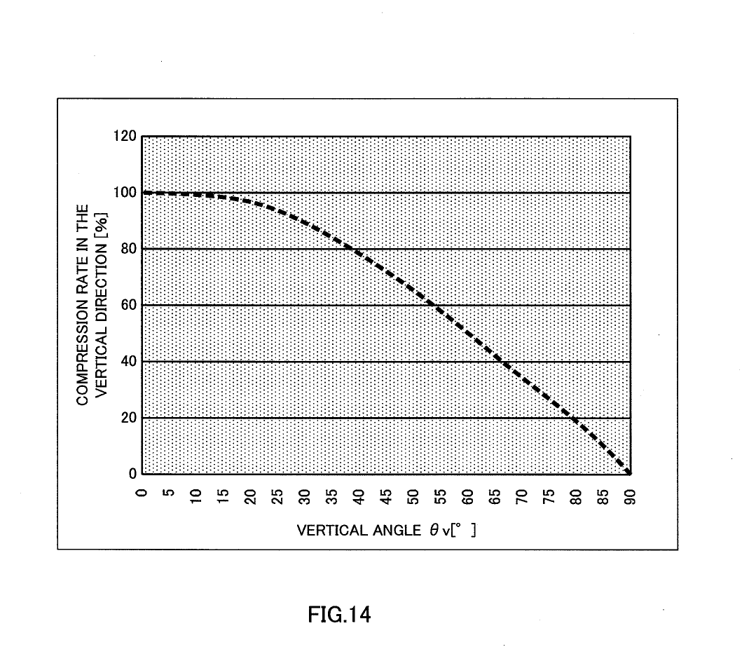

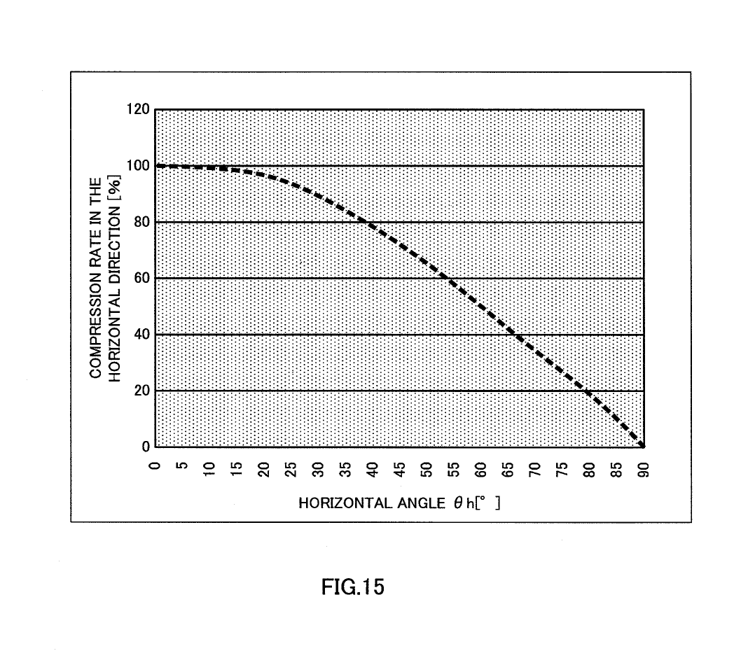

FIG. 10 is a diagram showing the state where two viewers view image or video displayed on different display surfaces. Viewer 1001 views an image or video displayed on display surface 1003, and viewer 1002 views an image or video displayed on display surface 1004. In this case, horizontal view angle θh1 of viewer 1001 and horizontal view angle θh2 of viewer 1002 are different. Thus, signal processing section 104 and signal processing section 904 independently expand the image or video in the horizontal direction using different expansion rates.

Here, horizontal view angle θh1, as shown in FIG. 10, is the angle formed by line 1006 connecting viewer 1001 and the center of display surface 1003 and line 1005 perpendicular to display surface 1003 and passing through the center of display surface 1003, when display surface 1003 is level with viewer 1001 and perpendicular to the ground. Here, horizontal view angle θh2, as shown in FIG. 10, is the angle formed by line 1008 connecting viewer 1002 and the center of display surface 1004 and line 1007 perpendicular to display surface 1004 and passing through the center of display surface 1004, when display surface 1004 is level with viewer 1002 and perpendicular to the ground. Furthermore, in embodiment 3, when a plurality of images or videos are viewed by a plurality of viewers, a viewer does not necessarily view the image or video displayed on the display surface closest to the viewer, and, thus, an it is preferable to provide inquiring means that asks each viewer whether or not the expansion rate needs to be changed either before the expansion rate is changed or before the image or video reflecting a changed expansion rate is displayed on the display surface. Further, embodiment 3 is not limited to the case where image of image data or video of video data are separately displayed on two display surfaces on a single display section, but can also be applied to a case where image of image data or video of video data are separately displayed on three or more display surfaces on a single display section.

Thus, according to embodiment 3, in addition to the effects of the above-described embodiment 1 and embodiment 2, when a plurality of viewers view different images or videos, the images or videos expanded at expansion rates ideal for each viewer are displayed, thereby allowing all viewers to view the images and videos at the original aspect ratios even when each viewer views image or video from an oblique direction.

### Embodiment 4

FIG. 11 is a block diagram showing the configuration of vehicle-mounted display apparatus 1100 according to Embodiment 4 of the present invention.

Vehicle-mounted display apparatus 1100 according to embodiment 4 has the same configuration as that of vehicle-mounted display apparatus 100 according to embodiment 1 shown in FIG. 1 with only view direction detection section 101 removed and view direction information acquisition section 1101 added, as shown in FIG. 11. Furthermore, the sections of FIG. 11 that have the same configurations as those of FIG. 1 are given the same reference numerals, and descriptions thereof are omitted.

View direction information acquisition section 1101 acquires view direction information, which is information about the view direction from which the viewer views the display surface. Then, view direction information acquisition section 1101 outputs the acquired view direction information to expansion rate control section 103. For example, a compression sensor provided in the seat detects the horizontal view angle and vertical view angle at which a viewer views the display surface when the viewer sits down in the seat, and view direction information acquisition section 1101 acquires information about the horizontal view angle and vertical view angle detected by the compression sensor as view direction. At this time, the horizontal view angle and vertical view angle of the seat with respect to the display surface are preset, and the compression sensor detects that a viewer is seated and at the same time detects the horizontal view angle and vertical view angle corresponding to the seat in which the viewer is seated. The compression sensor and view direction information acquisition section 1101 are connected by wire. Then, the compression sensor transmits the view direction information of the seat in which a seated viewer was detected to view direction information acquisition section 1101 by wire.

Expansion rate control section 103, using the horizontal view angle and the vertical view angle of the view direction information inputted from view direction information acquisition section 11101, refers to the expansion rate selection information stored in memory 102 and selects the respective expansion rates for the horizontal direction and the vertical direction. Then, expansion rate control section 103 outputs to signal processing section 104 expansion rate information which includes information about the selected expansion rate in the horizontal direction and expansion rate in the vertical direction. Furthermore, the display method for displaying image or video using vehicle-mounted display apparatus 1100 is the same as that of FIG. 2 or FIG. 6, and a description thereof is omitted.

Thus, according to embodiment 4, when image or video is viewed from an oblique direction, the image or video is expanded at expansion rates to ensure that the image or video is not viewed in a compressed state, thereby enabling a viewer to view image or video at the original aspect ratio and making the image or video easier to see.

Furthermore, while in embodiment 4 the view direction of the viewer is detected using a compression sensor, the present invention is not limited thereto and may apply a method of detecting a view direction set manually based on a view direction setting section provided in a navigation system installed in the front of the vehicle, a method of detecting a view direction set based on a remote operation using a remote control device, a method of detecting a view direction set manually using escutcheon (operation panel) buttons, or a method of detecting a view direction by the tightening of a seatbelt by the viewer, and may acquire the detected view direction as view direction information in view direction information acquisition section 1101. Further, embodiment 4 may be applied in cases where the images of image or video of video data are separately displayed on a plurality of display surfaces on a single display section as described in the above-mentioned embodiment 3.

While in the above-described embodiments 1 to 4 horizontal view angle θh and vertical view angle θv are detected as individual numerals and the expansion rates are selected per horizontal view angle θh and vertical view angle θv detected as a single numeral, the present invention is not limited thereto and horizontal view angle θh and vertical view angle θv may be separated into predetermined ranges such as greater than or equal to 0 degrees and less than 30 degrees, greater than or equal to 30 degrees and less than 60 degrees, and greater than or equal to 60 degrees and less than or equal to 90 degrees to change the expansion rates on a per predetermined range basis. Further, the above-described embodiments 1 to 4 are typical embodiments for a vehicle-mounted display apparatus. The present invention, however, is not limited thereto and the display apparatus of the above-described embodiments 1 to 4 may be applied to applications where the horizontal view angle and/or vertical view angle with respect to the display screen is substantially restricted.

According to the present invention, when image or video is viewed from an oblique angle, by expanding the image or video at predetermined expansion rates, it is possible to view the image or video at the original aspect ratio and make the image or video easier to see.

What is claimed is:

1. A display apparatus comprising:
a display section that displays image or video on a display surface;
an expansion rate control section that expands the image or video in a horizontal direction or a vertical direction at predetermined expansion rates and displays the image or video on the display surface; and
an expansion rate setting section that sets or selects the expansion rates used in the expansion rate control section.

2. The display apparatus according to claim 1, wherein: the expansion rate control section expands the image or video on one display surface at a plurality of different expansion rates and displays the image or video on the display surface.

3. The display apparatus according to claim 1, further comprising a view direction detection section that detects a direction from which a viewer views the display surface or an angle between a position of the viewer and the display surface,
wherein the expansion rate control section displays the image or video on the display surface at expansion rates corresponding to the detected direction.

4. The display apparatus according to claim 2, wherein the expansion rate control section displays the image or video on the display surface at expansion rates different for each position of the display surface according to the direction from which the viewer views the display surface or the angle between the position of the viewer and the display surface.

5. The display apparatus according to claim 2, wherein the expansion rate control section displays the image or video on the display surface at expansion rates increased in proportion to a distance from the viewer to the display surface.

6. The display apparatus according to claim 1, further comprising a storage section that stores expansion rate selection information that associates the direction from which the viewer views the display surface or the angle between the position of the viewer and the display surface and expansion rates,
wherein the expansion rate control section displays on the display surface the image or video expanded at expansion rates corresponding to the direction or the angle referring to the expansion rate selection information.

7. The display apparatus according to claim 1, wherein:
the display section separately displays a plurality of images or video on the display surface;
the expansion rate control section displays the images or video on a per display surface basis; and
the expansion rate setting section sets or selects the expansion rates on a per display surface basis.

8. A display method comprising:
an expansion rate control step of expanding image or video in a horizontal direction or a vertical direction at predetermined expansion rates;
an expansion rate setting step of setting or selecting the expansion rates used in the expansion rate control step; and
a display step of displaying the image or video expanded in the horizontal direction or the vertical direction at the expansion rates set or selected.

9. The display method according to claim 8, wherein the expansion rate setting step sets or selects the expansion rates according to a direction from which a viewer views the display surface or an angle between a position of the viewer and the display surface.
